(19) United States
(12) Patent Application Publication
(10) Pub. No.: US 2009/0071285 A1
(43) Pub. Date: Mar. 19, 2009

(54) Pedal arrangement for operating a clutch

(75) Inventor: Steve Lauderbaugh, Danville, OH (US)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 12/231,897

(22) Filed: Sep. 4, 2008

Related U.S. Application Data
(60) Provisional application No. 60/967,345, filed on Sep. 4, 2007.

(51) Int. Cl. G05G 1/30

(52) U.S. Cl. 74/512

(57) ABSTRACT

A clutch pedal arrangement for operating a clutch to provide a variable pedal force transmission ratio. The pedal arrangement includes a pivotally-supported pedal lever that pivots about a pivot axis. An operating member that is in operative engagement with the clutch is connected to the pedal lever for movement along a slotted slide bearing surface carried by the pedal lever to allow radial movement of the operating member relative to the pivot axis. The operating member is guided in and supported by the slide bearing surface of the pedal lever and is movable along at least one curved groove carried by a pedal support member.

### BACKGROUND OF THE INVENTION

1. Field of the Invention

The present invention relates to a pedal arrangement, in particular to a clutch pedal arrangement for operating a clutch with a variable pedal force transmission ratio. The pedal arrangement includes a pedal lever that is pivotally supported at a pivot axis, and an operating member that is carried by the pedal lever within a slotted slide bearing surface. The operating member is configured to be in operative engagement with the clutch, wherein the slide bearing surface is disposed at the pedal lever so that a radial movement of the operating member is facilitated with reference to the pivot axis.

2. Description of the Related Art

It is known in the art to actuate clutches with a clutch pedal carried by a lever. A control rod or a pull cable is connected to the pedal lever and to the clutch to operate the clutch. That pedal arrangement, however, has the disadvantage that the force needed to be applied to the pedal in order to operate the clutch is substantially directly proportional to the force that is required at the clutch to operate the clutch. That is disadvantageous, because the clutches that are typically used in motor vehicles have a non-linear force-displacement ratio when actuated by a user. That leads to the possibility for the force necessary for operating the clutch to be reduced when depressing the pedal lever further. That result is generally referred to as pedal load drop-off and is perceived as unpleasant by users, and thus constitutes a disadvantage. State-of-the-art devices that are intended to solve that problem have a complex configuration. A complex configuration, however, is also undesirable for reliability and cost reasons.

It is an object of the present invention to provide an improved clutch pedal arrangement that reduces the disadvantages of the state-of-the-art arrangements. In particular, it is an object of the present invention to provide a pedal arrangement that facilitates and influences in a simple manner the pedal force-pedal displacement relationship between a clutch pedal and a clutch to be operated.

### SUMMARY OF THE INVENTION

The object of the invention is achieved by a clutch pedal arrangement having a variable force transmission ratio for operating a clutch. The pedal arrangement includes a pedal lever that is pivotally supported at a pivot axis, and an operating member that is connected to the pedal lever for connection with a slide bearing surface carried by the pedal lever. The operating member is arranged to be in operative engagement with the clutch. The slide bearing surface is carried by the pedal lever so that a radial movement of the operating member with reference to the pivot axis is facilitated, wherein the operating member is exclusively guided and supported in the slide bearing surface of the pedal lever and moves along at least one groove carried by a pedal support element.

The present invention provides the advantage that the force transmission ratio between the pedal lever and the clutch can be influenced by a variation of the position of the operating member along the slide bearing surface. The pivot axis is preferably fixed in place, which means fixed relative to the pedal support element with reference to a motor vehicle receiving the pedal arrangement. Furthermore, the pivot axis preferably provides one degree of freedom in rotation, as it is known from state-of-the-art clutch pedals typically used in motor vehicles. By guiding the operating member along the groove in the pedal support element, the result is that the force transmission ratio achieved with the pedal lever depends upon the angular position of the pedal lever, so that the force necessary to move the pedal lever for operating the clutch is influenced. That is preferably accomplished by influencing the guidance of the operating member or by predetermining a defined guidance of the operating member.

Advantageously, the pedal support element groove is configured and disposed, so that the position of the operating member within the slide bearing surface of the pedal lever depends upon the angular position of the pedal lever and upon the configuration of the groove. That has the advantage that the position of the operating member within the slide bearing surface of the pedal lever can be influenced by the choice of the shape of the groove and as a function of the angular position of the pedal lever. In that manner, the force-displacement diagram can be influenced, which characterizes the actuation of the pedal lever and thus the actuation of the clutch by the pedal lever.

Preferably, the at least one groove and the pivot axis are disposed so that they do not move relative to one another. That is accomplished in a particularly simple manner by the groove and the pivot axis both being fixed to a pedal support element at a vehicle, wherein the pedal support element is configured for receiving the pedal arrangement.

Preferably, the operating member is a pin that is carried by a slot in the pedal lever that defines the slide bearing surface of the pedal lever and that also is guided in the at least one groove. The support of the operating member along the slide bearing surface of the pedal lever is preferably a rotatable support. The features have the advantage of a simple mechanical configuration for implementing a displacement-dependent force transmission ratio for clutch actuation. The operating member in the form of a pin is preferably also rotatably supported in the groove. The pin is preferably straight, which yields a simple configuration. For supporting the pin in the groove, methods or supports that are generally known in the art can be used.

The pedal arrangement preferably includes another groove, which has the same shape as the first groove, wherein the grooves are respectively disposed on opposite sides of the pedal lever. Thus, on the opposite side of the pedal lever means that the grooves are disposed on the side of the pedal lever with respect to the movement direction of the pedal lever. It is advantageous, in particular, that the grooves are substantially disposed in parallel to one another or parallel to the movement direction of the pedal lever. That, in turn, has the advantage that the mechanical configuration is comparatively simple.

It is furthermore advantageous that the pivot axis is disposed on a pedal support element and that the grooves also are configured in the pedal support element. That has the advantage of a particularly simple and robust configuration. The pedal support element can be a portion of the vehicle body or it can be a pedal receiver support element that is mounted to the vehicle body. Preferably, the pedal support element is a substantially U-shaped piece of sheet metal, in which the grooves are configured in the lateral arms of the U-shaped support element.

A push rod for actuating the clutch is preferably mounted to the operating member, wherein the mount is preferably a link mount. In particular, in conjunction with providing the operation member as a pin, a simple mechanical configuration is achieved in that manner.

The groove preferably is wave shaped. Thus, wave shaped means that the groove is of undulating, generally S-shaped form and is configured so that the radial distance of the operating member in the slide bearing surface from the pivot axis is initially increased or reduced, when actuating the pedal lever in one direction, and subsequently reduced again or increased upon further actuation of the pedal lever in the same direction. That means that while the pedal lever is actuated in one direction the position of the operating member moves in different directions along the slot in the pedal lever. It is particularly advantageous that upon actuation of the pedal lever by a user the operating member initially moves radially toward the pivot axis, and subsequently upon further actuation of the pedal lever in the same direction the operating member moves radially away from the pivot axis again. It thereby facilitates a reduction of the load drop that is typical for motor vehicle clutches. Wave form preferably also means that the shape of the groove includes at least two oppositely oriented curvatures.

The groove is preferably configured so that a force that is a function of the angular position of the pedal lever, and which is to be imparted to the pedal lever for actuating the clutch, is smoothed or substantially more uniform over an angular position movement range of the pedal lever. Substantially more uniform means that at angular positions of the pedal lever at which a particularly high actuation force normally has to be imparted when utilizing the known clutch pedal arrangements, that actuation force and the range of actuation forces over an adjacent angular range are reduced in the pedal arrangement in accordance with the present invention. In that way, when actuating the clutch, the maximum forces in the force-displacement diagram for the pedal arrangement in accordance with the present invention are reduced, and, furthermore, the pedal load drop after a maximum force is reduced.

Preferably, it is provided that the operating member includes a first pin and a second pin, which pins are in fixed positions relative to one another. Thus, the push rod is preferably connected to the pin that is radially closest to the pivot axis. The first pin and the second pin are preferably supported so that they are jointly movable along a slot and in a substantially radial direction relative to the pivot axis. The push rod is thus supported radially further inwardly toward the pedal arm rotation axis, so that the push rod completes the radial direction movement defined by the groove, but so that it performs a smaller movement in a tangential direction because of the smaller distance to the pedal arm rotation axis. In that way a greater variability of the path relationship of the pedal path to the reduction ratio relative to the displacement of the push rod can be implemented.

### BRIEF DESCRIPTION OF THE DRAWINGS

The structure, operation, and advantages of the present invention will become further apparent upon consideration of the following description, taken in conjunction with the accompanying drawings in which:

FIG. 1 is a perspective view of a first embodiment of a clutch pedal arrangement in accordance with the present invention;

FIG. 2 is a force-displacement diagram in which the respective forces to be applied when actuating a conventional pedal arrangement and a pedal arrangement in accordance with the present invention are shown; and

FIG. 3 is an exploded view of a second embodiment of a pedal arrangement in accordance with the present invention.

### DESCRIPTION OF THE PREFERRED EMBODIMENTS

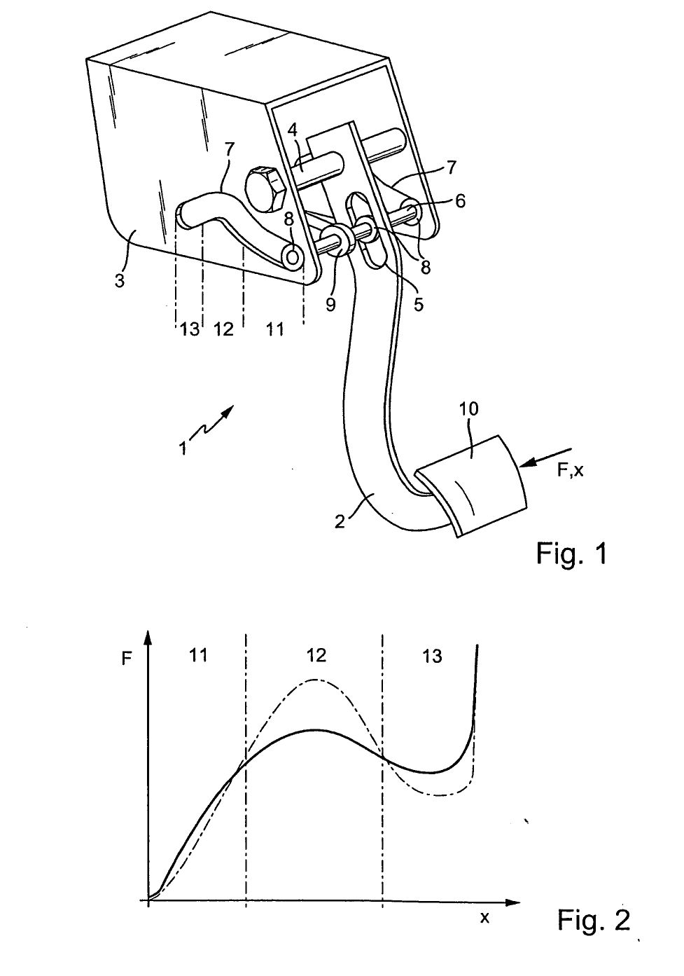

FIG. 1 shows a perspective view of a first embodiment of a pedal arrangement 1 in accordance with the present invention. A pedal lever 2 is pivotably supported in a U-shaped support element 3 on a pivot axis 4 that is supported by two lateral arms of the support element 3. The pedal lever 2 is carried by the pivot axis 4. The pivot axis 4 thus forms a hinge for the pedal lever 2. The pedal lever 2 includes a slide bearing surface 5 that is configured as an elongated opening or slot. The slide bearing surface 5 is oriented in a radial direction relative to the pivot axis 4.

An operating member 6 in the form of a pin is rotatably carried in the slide bearing surface or slot 5. The operating member 6 is also supported in two opposed grooves 7 that are formed in respective lateral arms of the support element 3. The support of the operating member 6 in the slide bearing surface or slot 5 and the in grooves 7 is effected by bearings 8. A push rod 9 is carried by the operating member 6, wherein the push rod 9 can operate a clutch (not shown). The operation of the pedal arrangement 1 in accordance with the invention is described below with the understanding that a user presses by foot a pedal 10 that is disposed at the pedal lever 2 in order to operate the clutch.

When one presses against the pedal 10, the pedal lever 2 is pivoted toward the left as viewed in FIG. 1. The operating member 6 moves in the grooves 7 that have the same shape and orientation and that are parallel to one another. Operating member 6 moves to the left, as viewed in FIG. 1, closer to the pivot axis 4, and simultaneously moves along the slide bearing surface 5. That causes the operating member 6, and thus the push rod 9, to be initially actuated with a relatively large lever arm length relative to pivot axis 4. The lever arm length is reduced during the course of the angular progression of the pedal lever 2 about pivot axis 4, because the operating member 6 is carried upward in the slide bearing surface 5, since it is guided by the upwardly-extending grooves 7.

Thus, substantially three portions of the groove 7 have to be distinguished. Those three portions of groove 7 are shown and identified in FIG. 1. Initially, as pedal 10 is depressed from its first, outermost position, the operating member 6 moves along a first region 11 of each of the grooves 7, in which first region the operating member is initially spaced from the pivot axis 4 at a first distance when the pedal 10 is at its outermost position. Thereafter, upon further inward movement of pedal 10, the operating member 6 moves into a second region 12 of each of the grooves 7, which causes the operating member 6 to move closer to the pivot axis 4, to a second distance from pivot axis 4 that is shorter than the first distance. When the pedal 10 is moved inward even further, so that the pedal lever 2 is rotated further clockwise, as viewed in FIG. 1, the operating member 6 moves into a third region 13, in which the distance of the operating member 6 from the pivot axis 4 increases again to a distance that is greater than the second distance. The pedal arrangement 1 in accordance with the invention provides a different pedal force-pedal displacement relationship when depressing the pedal 10, as compared with conventional pedal arrangements having a constant length lever arm that moves the operating member.

Under the presumption that a typical state-of-the-art clutch is actuated by a pivoting pedal arrangement, two pedal force-pedal displacement diagrams are shown in FIG. 2. The solid line in FIG. 2 represents the pedal force-pedal displacement relationship that is achieved with the pedal arrangement 1 in accordance with the present invention, and the dashed line in FIG. 2 represents a pedal force-pedal displacement relationship that is achieved with a conventional, constant length lever arm pedal arrangement. In FIG. 2, the same reference numerals as are shown in FIG. 1 represent the same regions of the grooves 7 as are shown in FIG. 1.

In FIG. 2, the movement variable of the pedal lever 2 is plotted on the horizontal or x-axis. The movement variable x can represent the length along an arc traversed by the pedal 10, or it can represent an angle that is traversed during movement of the pedal lever 2. The force F that is required to operate the clutch, as pedal 10 is depressed a distance represented along the movement variable x, is plotted on the vertical axis of FIG. 2. The movement variable x and the force F are also identified in FIG. 1.

When initially depressing the pedal 10, the first region 11 is traversed. In that region, when employing the pedal arrangement 1 in accordance with the present invention, the pedal force required for moving operating member 6 (represented by the solid line) is greater than the pedal force required for a conventional pedal arrangement (represented by the dashed line). In the following, second region 12, as pedal 10 continues to pivot about pivot axis 4, the maximum force that is required to depress the pedal 10 is reduced in the pedal arrangement 1 in accordance with the present invention. And in the final, third region 13, the force required for moving operating member 6 again increases as compared with a conventional pedal arrangement. As a consequence, the conventional pedal load drop-off occurring between the portions 12 and 13 is significantly reduced. Overall, as shown in FIG. 2, the force-displacement curve for the arrangement in accordance with the present invention is smoothed out as compared with a conventional pedal arrangement.

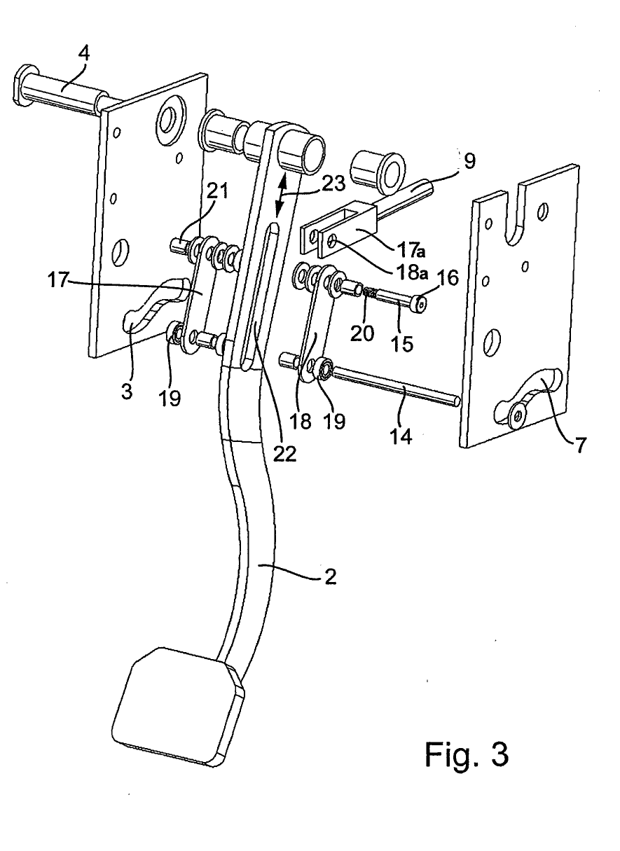

FIG. 3 shows an exploded view of a second embodiment of the present invention. In the embodiments shown in FIGS. 1 and 3 identical components are identified by the same reference numerals, and they are therefore not described again. In the embodiment in accordance with FIG. 3, the operating member is formed as two components and includes a first pin 14 and a second pin 15. The first pin 14 interacts with the groove 7, while the second pin 15 is used for connection with the push rod 9. The second pin 15 includes a pin head 16 and a threaded end 20, onto which a safety nut 21 is threaded. The pins 14 and 15 are connected by connecting links 17 and 18, which are disposed on respective opposite sides of the pedal lever 2. The push rod 9 is connected to the second pin 15 by a fork 17a. For that purpose, the fork 17a includes two arms that each includes a bore 18a through which the second pin 15 is inserted. The first pin 14 is provided with support rings 19 on both ends, which can be plastic rings, ball bearings, or the like, and increase the contact surface area and thus reduce the surface pressure and the friction at the surfaces of the grooves 7. The first pin 14 and the second pin 15 are each received in and guided within an elongated slot 22 formed in pedal lever 2, so that they can be jointly moved in the longitudinal direction of slot 22, which direction is indicated by a double-headed arrow 23.

When it is depressed, the pedal lever 2 pivots about the pivot axis 4, as described in connection with the previous embodiment, wherein the first pin 14 moves along the groove 7. Thus, the first pin 14 and also the second pin 15, which is spaced from but connected to the first pin 14 by the connecting links 17 and 18, are each moved along the slot 22, so that the effective length of the lever arm that operates the push rod 9 changes relative to the pivot axis 4, thus achieving a variable pedal force transmission ratio.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A clutch pedal operating arrangement, said arrangement providing a variable force transmission ratio, said pedal arrangement comprising: a pedal lever rotatably supported at a pivot axis and having an elongated slot; an operating member operatively connected with a clutch and slidably received in the pedal lever slot; wherein the pedal lever slot is disposed to enable radial movement of the operating member relative to the pivot axis; and wherein the operating member is exclusively guided and supported for movement within the pedal lever slot and within at least one groove in a pedal support member that is spaced laterally from the pedal lever slot.

2. A pedal arrangement in accordance with claim 1, wherein the groove is configured and disposed, so that the position of the operating member within the pedal lever slot is a function of the angular position of the pedal relative to the pivot axis and the configuration of the at least one groove.

3. A pedal arrangement in accordance with claim 1, wherein the at least one groove and the pivot axis are at a fixed spacing relative to each other.

4. A pedal arrangement in accordance with claim 1, wherein the operating member is a pin that extends through and is carried within the pedal lever slot, and extends to and is guided within the at least one groove.

5. A pedal arrangement in accordance with claim 1, including a pair of identically shaped grooves carried by the pedal support member, wherein the grooves are disposed on respective opposite sides of the pedal lever.

6. A pedal arrangement in accordance with claim 5, wherein the pivot axis is carried by the pedal support member and the grooves are provided in the pedal support member.

7. A pedal arrangement in accordance with claim 1, including a push rod connected with the operating member for actuating the clutch.

8. A pedal arrangement in accordance with claim 1, wherein the at least one groove is configured as a wave form.

9. A pedal arrangement in accordance with claim 1, wherein the at least one groove is configured so that a force applied to the pedal lever for actuating the clutch by changing the angular position of the pedal lever over a portion of an angular operating range, is substantially uniform over that angular operating range.

10. A pedal arrangement in accordance with claim 1, wherein the operating member includes a first pin and a second pin that are spaced in fixed relationship to each other, wherein the first pin is closer to the pivot axis than is the second pin.

11. A pedal arrangement in accordance with claim 10, wherein a push rod connected with the operating member for actuating the clutch is connected to the first pin.

12. A pedal arrangement in accordance with claim 10, wherein the first pin and the second pin are jointly movable in a radial direction relative to the pivot axis and along the pedal lever slot.
